(19) United States
(12) Patent Application Publication
(10) Pub. No.: US 2003/0115610 A1
(43) Pub. Date: Jun. 19, 2003

(54) Cable modem (or xDSL modem) integrated with access point

(76) Inventor: Insik Cho, Granada Hills, CA (US)

Correspondence Address: INSIK CHO, ADVANCED RF TECHNOLOGIES, SUITE 200, 2607 COLORADO BLVD., LOS ANGELES, CA, 90041, US

(21) Appl. No.: 10/014,536

(22) Filed: Dec. 14, 2001

(51) Int. Cl. H04N 7/173; H04B 1/38; H04L 5/16

(52) U.S. Cl. 725/111; 375/222

(57) ABSTRACT

The present invention integrates a cable or DSL modem unit and a wireless AP into a one unified unit. It enables home WLAN users to connect to the Internet more easily and conveniently by getting rid of unnecessary wiring between modem unit and AP. It also improves data fidelity by reducing data loss which may occur during data travel to and from modem unit and AP. By combining two separate units into one unit, the present invention contributes to reduce manufacturing cost by eliminating overlapping components and separate enclosure.

### CROSS REFERENCE TO RELATED APPLICATIONS NOT APPLICABLE

### STATEMENT REGARDING FEDERALLY SPONSORED RESEARCH OR DEVELOPMENT

NOT APPLICABLE

### REFERENCE TO A MICROFICHE APPENDIX NOT APPLICABLE

### BACKGROUND OF THE INVENTION

1. Field of the Invention

The present invention generally relates to home networking through wireless local access network (“WLAN”) and residential Internet access through broadband technologies either by cable modem or digital subscriber line (“DSL”).

2. Description of the Prior Art

As the number of multiple-computer homes increases, so does the need for home networking. Home computer users, more and more, want to share files, computer peripherals (printer, scanner, storage device, etc.) and, most importantly, share the Internet access among multiple computers without a cumbersome and costly local access network (“LAN”). That is why many manufacturers recently introduced to the market various home wireless local access network (“WLAN”) products.

Home WLAN is, to its simplest form, composed of an access point and multiple adapters. The access point modifies digital data to an RF signal and distributes the RF signal to each adapter which is connected to each computer. With this set up, home WLAN users can share files and peripherals.

However, in order to share the Internet connection using home WLAN, the access point must be connected to an Internet gateway, that is, a DSL modem, or a cable modem. Currently, neither a cable modem nor a DSL modem is integrated with the access point. Therefore, home WLAN users must wire from RJ-45 on the wall to either a cable or DSL modem and from there to the access point. This causes unnecessary wiring, increased noise and fidelity loss.

### SUMMARY OF THE INVENTION

Cable modem (or xDSL modem) incorporated with the access point (“the present invention”) integrates a cable/DSL modem unit and an access point in WLAN into one unified unit. By combining the two separate units, the present invention simplifies the design by getting rid of overlapping components. The simplicity of design improves the data fidelity by reducing the loss, which inevitably occurs during unnecessary data travel between separate modem and access point units. The present invention is also expected to bring the manufacturing cost down compared to the total cost of manufacturing the modem and access point units separately.

These, together with other objects of the invention, are pointed out in the claims annexed to and forming a part of this disclosure. For a better understanding of the present invention, its operating advantages, and the specific objects attained by its use, references should be made to the accompanying drawings and descriptive matter in which there are illustrated preferred embodiments of the invention.

### BRIEF DESCRIPTION OF THE DRAWINGS

For a better understanding of the principle and nature of the present invention, references should be made to the following detailed descriptions taken in consideration with the accompanying drawings in which:

FIG. 1 is a diagram showing the traditional wireless Internet access system configuration through a DSL modem.

FIG. 2 is a diagram showing the traditional wireless Internet access system configuration through a cable modem.

FIG. 3 is an improved Wireless Internet Access System using UWDSLAP (Unified Wireless Digital Subscriber Line Access Point) System.

FIG. 4 is an improved Wireless Internet Access System using UWCMAP (Unified Wireless Cable Modem Access Point) System.

### DETAILED DESCRIPTION OF THE PREFERRED EMBODIMENT

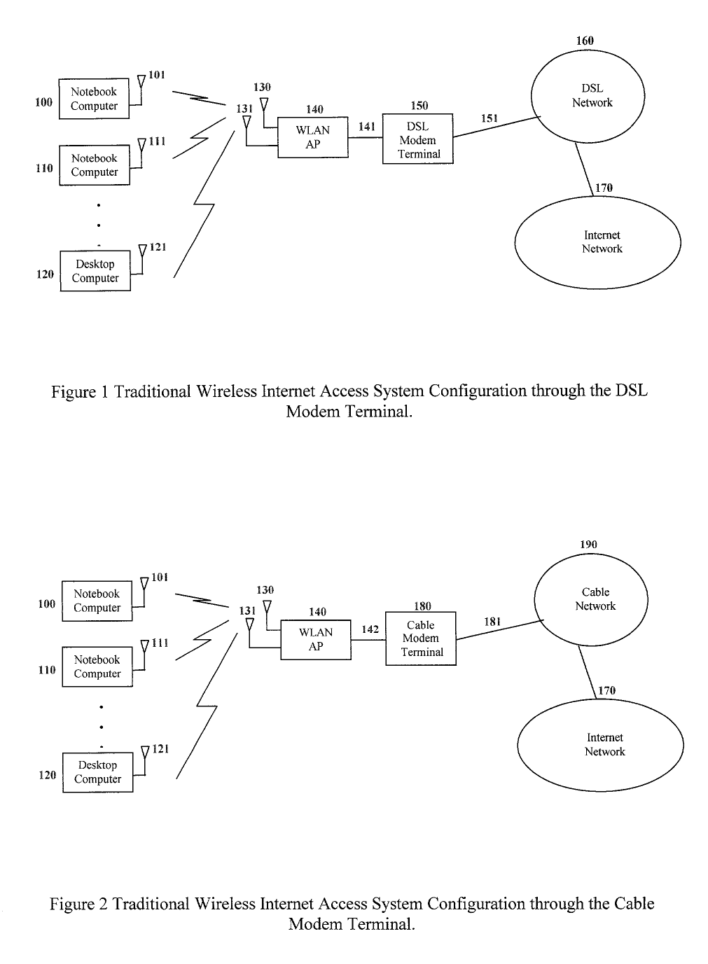

FIG. 1 exemplifies DSL subscribers' traditional home wireless networking set-up, using DSL Modem Terminal 150 and Access Point (“AP”) 140. Down data travels from the Internet Network 170 to the End Terminals 100, 110, 120 through a DSL Network 160, DSL Modem 150, WLAN AP 140 and WLAN Card 101, 111, 121. In the final lag from WLAN AP 140 to WLAN Card 101, 111, 121, either of two antennas 130, 131 attached to WLAN AP 140 transmits the signal to the End Terminals 100, 110, 120 and the transmitted signal is received by WLAN Cards 101, 111, 121. Likewise, up data travels, in the reverse order, from computers 100, 110, 120 to WLAN Cards 101, 111, 121, then is received by two antennas 130, 131 of WLAN AP 140, and then travels to the DSL Network 160 via DSL Modem 150, then finally to Internet Network 170. In this way, the computers 100, 110, 120 share the Internet connection through wireless networking.

FIG. 2 exemplifies cable modem subscribers' traditional home wireless networking set-up, using Cable Modem Terminal 180 and AP 140. Down data travels from Internet Network 170 to the End Terminals 100, 110, 120 through a Cable Network 190, Cable Modem Terminal 180, WLAN AP 140 and WLAN Card 101, 111, 121. In the final lag from WLAN AP 140 to WLAN Card 101, 111, 121, either of two antennas 130, 131 attached to WLAN AP 140 transmits the signal the End Terminals 100, 110, 120 and the transmitted signal is received by WLAN Cards 101, 111, 121. Likewise, up data travels, in the reverse order, from computers 100, 110, 120 to WLAN Cards 101, 111, 121, then is received by two antennas 130, 131 of WLAN AP 140, and then travels to Cable Network 190 via Cable Modem 180, then finally to Internet Network 170. In this way, the computers 100, 110, 120 share the Internet connection through wireless networking.

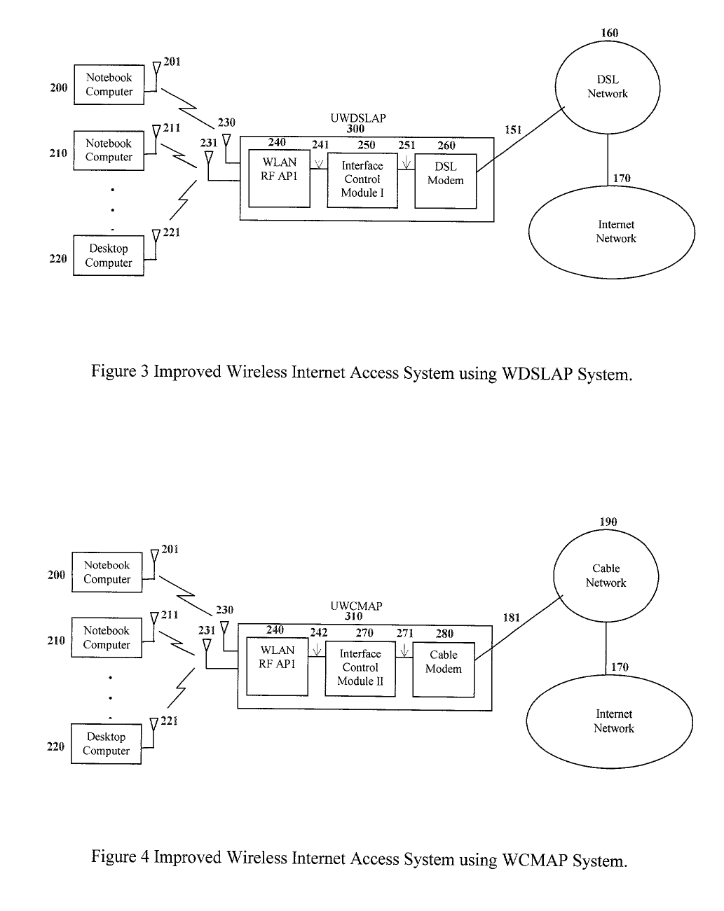

FIG. 3 embodies Unified Wireless Digital Subscriber Line AP (UWDSLAP) 300. Down data travels from Internet Network 170 to the UWDSLAP 300 which is located inside a house through the DSL Network 160. Inside of the UWDSLAP 300 there are DSL Modem 260, Interface Control Module I 250, and WLAN RF AP1 240. DSL Data Signal 151 from DSL Network 160 is delivered to DSL Modem 260, the Modem modifies the Signal 151, the modified Signal 251 goes to Interface Control Module I 250, and ultimately to WLAN RF AP1 240. The output signal from either of two Antennas 230, 231 is received by WLAN Cards 201, 211, 221 which are housed in Computers 200, 210, 220. Up data travels through the above units in the reverse order as the down data.

FIG. 4 embodies Unified Wireless Cable Modem AP (UWCMAP) 310. Down data travels from Internet Network 170 to the UWCMAP 310 which is located inside a house through the Cable Network 190. Inside UWCMAP 310 there are Cable Modem 280, Interface Control Module II 270, and WLAN RF AT1 240. Cable Data Signal 181 from Cable Network 190 is delivered to Cable Modem 280, the Modem modifies the Signal 181, the modified Signal 271 goes to Interface Control Module II 270, and ultimately to WLAN RF AP1 240. The output signal from either of two Antennas 230, 231 is received by WLAN Cards 201, 211, 221 which are housed in Computers 200, 210, 220. Up data travel through the above units in the reverse order as the down data.

What is claimed as being new and therefore desired to be protected by Letter Patent in the United States is as follows:

1. DSL Modem integrated with wireless RF AP (UWDSLAP) in FIG. 3.
a) Interface which enables DSL cable modem and AP to interact in FIG. 3.

2. Cable Modem integrated with wireless RF AP (UWCMAP) in FIG. 4.
b) Interface which enables Cable Modem and AP to interact in FIG. 4.
